(19) United States
(12) Patent Application Publication
(10) Pub. No.: US 2009/0004433 A1
(43) Pub. Date: Jan. 1, 2009

(54) Fluid Absorbing and/or Disinfecting Surfacing Materials

(76) Inventors: Marc Privitera, Walnut Creek, CA (US); David Lestage, Livermore, CA (US); Gregory Van Buskirk, Danville, CA (US); Jessica Chung, Milpitas, CA (US); Elizabeth Lane, San Francisco, CA (US); Marcus Wang, Oakland, CA (US); Jason White, Pleasanton, CA (US)

Correspondence Address: THE CLOROX COMPANY, P.O. BOX 24305, OAKLAND, CA, 94623-1305, US

(21) Appl. No.: 11/768,658

(22) Filed: Jun. 26, 2007

(51) Int. Cl. B32B 5/16; B32B 27/00; B32B 7/00; B32B 27/32

(52) U.S. Cl. 428/143; 428/220; 428/339; 428/411.1; 428/500; 428/98

(57) ABSTRACT

A plastic film that includes one or more plastic layers and one or more types of primary additives. The types of primary additive can include a liquid absorbing material, a gas absorbing material, a biocide, a heat generating material, and/or a foaming agent.

The present invention pertains to the art of materials that include one or more additives, and more particularly to a plastic sheet or film, or a tile, mat or pouch that includes one or more primary additives, and even more particularly to plastic sheets or films, or a tile, mat or pouch that includes an absorbent material, a biocide, a heat generating material, and/or a foaming material.

### BACKGROUND OF THE INVENTION

Liners are commonly used to protect surfaces from damage caused by spills, leaking packaging, etc. Paper and plastic liners are common types of liners. Paper liners are commonly used when there is a need to absorb liquids since paper is a generally absorbent material. For example, paper liners (e.g., paper towels, etc.) are commonly placed on glass or plastic shelves in refrigerators to absorb liquids such as from recently washed food items, etc. The paper towel is used to absorb the water from the wet food item to prevent the water from accumulating on the refrigerator shelf and/or from damaging adjacently positioned foods (e.g., cheese, breads, etc.) and/or food packaging (e.g., cardboard containers, etc.).

Standing or accumulated water on the shelf is not only aesthetically undesirable, the standing or accumulated water can cause staining on the shelf and/or become a breeding ground for mold, fungus, bacteria, undesired odors, etc. The paper liner is typically not a very durable liner and is susceptible to tearing, especially when items are removed from and/or inserted onto the paper liner, and/or the paper liner becomes damp or wet. The paper liner is also a non-transparent liner, thus the use of the paper liner may be aesthetically unacceptable for certain uses.

Plastic liners are also commonly used to protect a surface from damage that can be caused by liquids. The plastic material is typically a nonabsorbent layer that forms a barrier between the liquid and a shelf or other surface. The plastic liner can be formed of a clear or transparent material. As such, in some applications, the plastic liner can be a more desirable material to use than a paper liner. The plastic liner is also typically a more durable liner than a paper liner, especially when liquids are spilled on the liner. As such, surfaces that can be damaged by liquids (e.g., wood shelves, etc.) can be protected from the spilled liquid when using plastic liners. The durability of plastic liners can also provide some protection of scratching and other types of disfigurement from the shelf.

Although the plastic liner can be used to effectively function as a barrier to spilled liquids, the plastic liner must typically be removed and/or cleaned with an absorbent material (e.g., sponge, paper towel, etc.) to remove the standing liquid on the plastic liner. If the plastic liner is removed with liquid on the liner, some of the liquid can drip from the plastic liner onto a shelf if appropriate actions are not taken. Furthermore, if the liquid is not removed from the surface of the plastic liner, the accumulated liquid can damage adjacently positioned foods and/or food packaging, and/or become a breeding ground for mold, fungus, bacteria, undesired odors, etc.

In view of the currently available liners, there is a need for an improved plastic film or sheet that can be used as a liner for shelves, packaging materials, etc. and which plastic film or sheet has improved properties over standard types of plastic sheets.

### SUMMARY OF THE INVENTION

The present invention is directed to a new type of plastic film that includes one or more primary additives to enhance the physical properties of the plastic film. In one non-limiting application of the plastic film of the present invention, the plastic film is designed to at least partially absorb one or more liquids and/or gasses, and/or to at least partially disinfect, sanitize, and/or sterilize one or more organisms and/or materials that come in contact with the plastic film. The plastic film is also designed to have sufficient integrity retention so as to resist degradation of the integrity of the plastic film when one or more liquids and/or gasses are spilled or otherwise come in contact with the plastic film, and/or when the plastic film at least partially absorbs one or more liquids and/or gasses that come in contact with the plastic film. The plastic film can be used in a variety of applications such as, but not limited to, shelf liners (e.g., refrigerator shelves, pantry shelves, dish and/or glassware shelves, linen shelves, utility and/or storage shelves, etc.), beverage bottle and/or can pouches and/or covers, shelf tiles or mats, clothing covers, packaging covers and/or protectors, plastic absorbable and disposable towels and/or pads, furniture covers, toilet seat covers, counter top liners, floor covers, microwave liners, litter box liners, animal cage liners, document holders and/or protectors, book covers and/or protectors, picture covers and/or protectors, storage bags, bottle covers or sleeves, glassware covers or sleeves, container covers or sleeves, etc. In essence, the plastic liner can potentially be used in almost any application that requires the protection of one or more surfaces and/or materials from liquids, undesired gases and/or undesired organisms. Two specific non-limiting applications for the plastic film are 1) a shelf liner, mat or tile for use on a refrigerator shelf, a freezer shelf, a pantry shelf, and/or a clothing drawer or shelf, and 2) a bottle, can or container sleeve, cover or jacket. The shelf liner, tile or mat can be designed so that food items, dishware, glassware, silverware or other food containers can be placed on the shelf liner, tile or mat so as to protect the surface underneath the shelf liner, tile or mat from moisture and/or other types of materials, and/or other types of contact with the surface that could damage or deface the surface. The sleeve, jacket, or cover can be designed to fit partially or fully about a bottle, can and/or other type of container. For example when a cold beverage is removed from a refrigerator or the like, the can, bottle or container for the beverage begins to sweat, and thereby cause water to form about the base of the can, bottle or container. The sleeve, jacket, or cover can be used to absorb the water that forms on the side of the can, bottle or container thereby inhibiting or preventing the water from contacting a surface that could be damaged and/or defaced from the water. As can be appreciated, the plastic film can have other applications not listed above (e.g., cleaning wipes, plastic warming inserts, etc.) The thickness of the plastic film and/or the composition of the plastic material used to form the plastic film can be selected to achieve certain desired properties for the plastic film (e.g., durability, flexibility, melting point, microwave safe, formability, stretchability, chemical resistant properties, gas permeability properties, temperature resistant properties, clinging properties, gripping properties, etc.). The composition of the plastic film is selected to maintain its desired function in one or more environments (e.g., freezer, refrigerator, inside ambient environments, outside ambient environments, etc.). For example, the plastic film could be designed for use in both a freezer and refrigerator environment.

In one non-limiting aspect of the invention, the plastic material used to at least partially form the novel plastic film of the present invention is a polyolefin polymer. Many types of polyolefin polymers can be used such as, but not limited to, polypropylene polymers, polyethylene polymers, copolymers, homopolymers and/or blends of polypropylene polymers and/or polyethylene polymers, etc. In one non-limiting embodiment of the invention, the plastic film is formed of or includes a linear low density polyethylene (LLDPE), high density polyethylene (HDPE), polypropylene, polyamide, polyester, or some mixtures thereof. Non-limiting examples of materials that can be used to form the plastic film are disclosed in U.S. Pat. Nos. 4,076,698; 4,205,021; 4,350,655; 4,472,328; and 4,929,303, all of which are incorporated herein by reference. In one non-limiting example, the plastic film can be at least partially formed of a polymer that includes interpolymerized comonomers having ethylene and at least one ∀-olefin containing from 3 to 18 carbon atoms, and the polymer having a density of at least about 0.85 g/cm³. As can be appreciated, the plastic film can include other types of polymers. The olefin that is used to at least partially form the polymer of the plastic material generally includes, but is not limited to, 1-hexene, 1-octene, 1-decene, 1-dodecene, 1-tetradecene, 1-octadecene, 3-methyl-1-butene, 3-methyl-1-pentene, 3-methyl-1-hexene, 4-methyl-1-hexene, 5-methyl-1-hexene, 3-methyl-1-heptene and 5-methyl-1-heptene, 1-butene, 1-pentene, 1-hexene, 4-methyl-1-pentene. In still another and/or alternative non-limiting embodiment of the invention, the plastic film is formed of or includes a LLDPE or HDPE that has a melting temperature of about 150-600 EF, typically about 175-500 EF, and more typically about 200-450 EF. In yet another and/or alternative non-limiting embodiment of the invention, the novel plastic film of the present invention has a film thickness of less than about 20 mils; however, greater thicknesses can be used. In one non-limiting aspect of this embodiment, the novel plastic film has a thickness of about 2-10 mils, and typically about 3-7 mils.

In another and/or alternative non-limiting aspect of the present invention, the plastic film can include at least one liquid absorbing material. The liquid absorbing material is selected to at least partially absorb one or more liquids that contact the plastic film. Many different types of liquid absorbing materials can be used in the plastic film. The liquid absorbing material can be a polymer, clay, mineral, salt, organic, etc. Non-limiting examples of such materials can include, but are not limited to, silica (e.g., synthetic silica, sand, rice hulls, wood pulp, feathers, etc.), particulate soils, alkali metal carboxylate salt, kaolin, sepiolite, bentonite (e.g., sodium bentonite, etc.), polyacrylamide polymers (e.g., sodium polyacrylate, isopropyl acrylamides, etc.), AGP 50, calcium carbonate, talc, kaolin, diatomaceous earth, magnesium carbonate, barium carbonate, magnesium sulfate, barium sulfate, calcium sulfate, aluminum hydroxide, zinc oxide, magnesium hydroxide, calcium oxide, magnesium oxide, titanium dioxide, alumina, mica, asbestos powder, glass powder, zeolite, or some mixture thereof. The amount of the liquid absorbing material in the plastic film is selected to obtain the desired amount of absorbency of the plastic film. The amount of the liquid absorbing material in the plastic film is also selected so as to not adversely affect the integrity of the plastic film during the formation or shelf life of the plastic film. The amount of the liquid absorbing material in the plastic film can also be selected so as to not adversely affect the integrity of the plastic film after liquids have contacted and have been at least partially absorbed by the plastic film; however, this is not required. In one non-limiting embodiment of the invention, the plastic film includes no more than about 75 weight percent liquid absorbing material. In one non-limiting aspect of this embodiment, the plastic film includes about 1-70 weight percent liquid absorbing material, and typically about 2-65 weight percent liquid absorbing material. As can be appreciated, other weight percentages can be used. In another and/or alternative non-limiting embodiment of the invention, the plastic film can be designed to at least partially absorb liquids on one or both sides of the plastic film, and/or on different regions of the plastic film.

In still another and/or alternative non-limiting aspect of the present invention, the plastic film can include at least one gas absorbing material. The gas absorbing material is selected to at least partially absorb one or more gasses that contact the plastic film. The absorption of one or more gasses by the plastic film can be used to reduce or eliminate odors, and/or protect materials from various types of gases (e.g., reduce the rate of oxidation of covered materials, etc.). As can be appreciated, there can be other or additional uses for the gas absorbing plastic film. Many different types of materials can be used to absorb one or more gases. The gas absorbing material can be a polymer, mineral, clay, salt, etc. Non-limiting examples of such materials can include, but are not limited to, activated carbon [i.e., carbon black, etc.], sodium bicarbonate, montmorillonite clay, zeolites (e.g., analcime, chabazite, heulandite, natrolite, phillipsite, stibite, etc.), cyclodextrin (e.g., alpha and/or beta cyclodextrin, etc.), acid salt forming materials, sodium permanganate, sodium carbonate, sodium phosphate, or mixtures thereof. The amount of the gas absorbing material in the plastic film is selected to obtain the desired amount of gas absorbency of the plastic film. The amount of the gas absorbing material in the plastic film is also selected so as to not adversely affect the integrity of the plastic film during the formation or shelf life of the plastic film. The amount of the gas absorbing material in the plastic film is also be selected so as to not adversely affect the integrity of the plastic film after gases have contacted and have been at least partially absorbed by the plastic film; however, this is not required. In one non-limiting embodiment of the invention, the plastic film includes no more than about 75 weight percent gas absorbing material. In one non-limiting aspect of this embodiment, the plastic film includes about 1-70 weight percent gas absorbing material, and typically about 2-65 weight percent gas absorbing material. As can be appreciated, other weight percentages can be used. In another and/or alternative non-limiting embodiment of the invention, the plastic film can be designed to at least partially absorb gases on one or both sides of the plastic film, and/or on different regions of the plastic film.

In still another and/or alternative non-limiting aspect of the present invention, the plastic film can include at least one biocide. The biocide is selected to at least partially inhibit, prevent, reduce or eliminate the growth of one or more undesirable organisms (e.g., bacteria, fungus, viruses, inserts, etc.) that contact and/or are in close proximity to the plastic film. The prevention or elimination of one or more organisms on and/or about the plastic film can be used to at least partially disinfect, sanitize, and/or sterilize regions on and/or about the plastic film. For instance, liquids that are in contact with the plastic film can become a breeding ground for unwanted organisms. In one non-limiting application, the biocide in the plastic film can be used to inhibit or prevent the growth of such unwanted organisms. Certain types of organisms can damage and/or destroy food and/or other types of articles, stain articles, and/or create undesired odors. In another non-limiting application, the plastic film can be used to seal clothing, books, etc. and be used to inhibit and/or eliminate microorganisms (e.g., insects, mold, etc.) that could damage and/or destroy such articles. As can be appreciated, other or additional applications of the biocide plastic film can be used. As used herein, the term “disinfect” shall mean the elimination of many or all pathogenic microorganisms on the surface with the exception of bacterial endospores. As used herein, the term “sanitize” shall mean the reduction of contaminants on the device surface to levels considered safe according to public health ordinances, or that reduces the bacterial population by significant numbers (e.g., at least 90%) where public health requirements have not been established. As used herein, the term “sterilize” shall mean the substantially complete elimination or destruction of all forms of microbial life. Many different types of biocides can be used in the plastic film. Non-limiting examples of biocides that can be used include, but are not limited to, cationic biocides (e.g., biguanide compounds, quaternary ammonium salts, etc.), alcohols, peroxides, boric acid and borates, chlorinated hydrocarbons, organometallics, halogen-releasing compounds, mercury compounds, metallic salts, chitosan, hypochlorite producing agent, creosote bush particles, hemp particles, antimicrobial essential oils, pine oil, organic sulfur compounds, iodine compounds, silver nitrate, quaternary phosphate compounds, phenolics, APG, silver nano-particles, lactic acid crystals, alternate starch agglomerates, or some mixture thereof. The amount of the biocide in the plastic film is selected to obtain the desired amount of organism prevention and/or protection by the plastic film. The amount of the biocide in the plastic film is also selected so as to not adversely affect the integrity of the plastic film during the formation or shelf life of the plastic film. In one non-limiting embodiment of the invention, the plastic film includes no more than about 75 weight percent biocide. In one non-limiting aspect of this embodiment, the plastic film includes about 1-70 weight percent biocide, and typically about 2-65 weight percent biocide. As can be appreciated, other weight percentages can be used. In another and/or alternative non-limiting embodiment of the invention, the plastic film can be designed to at least partially disinfect, sanitize, and/or sterilize organisms on one or both sides of the plastic film, and/or on different regions of the plastic film.

In yet another and/or alternative non-limiting aspect of the present invention, the plastic film can include at least one heat generating material. The heat generating material is selected to at least partially generate heat when the heat generating material comes in contact with a fluid such as, but not limited to, water, oxygen, etc. The generation of heat by the plastic film can be used to warm and/or defrost cold items, provide heat in cold environments (e.g., shoe and/or glove inserts, etc.), etc. As can be appreciated, other or additional applications of the heat generating plastic film can be used. Many different types of heat generating materials can be used in the plastic film. Non-limiting examples of heat generating materials that can be used include, but are not limited to, magnesium sulfate, calcium oxide, lithium chloride, magnesium chloride, sodium sulfate, aluminum oxide, aluminum sulfate, aluminum fluoride, aluminum nitrate, lithium nitrate, sodium borate, beryllium sulfate, sodium phosphate, calcium chloride, zinc sulfate, aluminum chloride, zinc chloride, etc. The amount of the heat generating material in the plastic film is selected to obtain the desired amount of heat generation by the plastic film. The amount of the heat generating material in the plastic film is also selected so as to not adversely affect the integrity of the plastic film during the formation of the plastic film. The amount of the heat generating material in the plastic film can also be selected so as to not adversely affect the integrity of the plastic film after the heat generating material has contacted a fluid and has been generating heat in the plastic film; however, this is not required. In one non-limiting embodiment of the invention, the plastic film includes no more than about 75 weight percent heat generating material. In one non-limiting aspect of this embodiment, the plastic film includes about 1-70 weight percent heat generating material, and typically about 2-65 weight percent heat generating material. As can be appreciated, other weight percentages can be used. In another and/or alternative non-limiting embodiment of the invention, the plastic film can be designed to at least partially generate heat on one or both sides of the plastic film, and/or on different regions of the plastic film.

In still yet another and/or alternative non-limiting aspect of the present invention, the plastic film can include at least one foaming agent. The foaming agent is selected to at least partially generate foam when the foaming agent comes in contact with a fluid such as, but not limited to, water, oxygen, etc. The generation of foam in the plastic film can be used to facilitate in the cleaning of a surface, facilitate in creating a lubricating film on the plastic film, facilitate in releasing a cleaning and/or disinfecting agent, etc. As can be appreciated, other or additional applications of the foaming agent in the plastic film can be used. Many different types of foaming agents can be used in the plastic film. Non-limiting examples of foaming agents that can be used include, but are not limited to, alkyl poly glucoside, polyxyethylene and/or polyoxy propylene type of nonionic surfactant, etc. The amount of the foaming agent in the plastic film is selected to obtain the desired amount of foam generation by the plastic film. The amount of the foaming agent in the plastic film is also selected so as to not adversely affect the integrity of the plastic film during the formation of the plastic film. The amount of the foaming agent in the plastic film can also be selected so as to not adversely affect the integrity of the plastic film after the foaming agent has contacted a fluid and creates in the plastic film; however, this is not required. In one non-limiting embodiment of the invention, the plastic film includes no more than about 75 weight percent foaming agent. In one non-limiting aspect of this embodiment, the plastic film includes about 1-70 weight percent foaming agent, and typically about 2-65 weight percent foaming agent. As can be appreciated, other weight percentages can be used. In another and/or alternative non-limiting embodiment of the invention, the plastic film can be designed to at least partially generate foam on one or both sides of the plastic film, and/or on different regions of the plastic film.

In another and/or alternative non-limiting aspect of the present invention, the plastic film can include a plurality of different materials that can perform different functions. For example, the plastic film can include any combination of a liquid absorbing material, a gas absorbing material, biocide material, heat generating material, and a foaming agent. As such, the plastic film can include two or more different primary additives to enable the plastic film to have multiple features. The plastic film can also include other materials (e.g., chelators, sequestration agents, pH adjusters, olefinic elastomer, coloring agents, UV protection agents, etc.) to enhance or affect one or more properties of the plastic film; however, this is not required. For instance, an olefinic elastomer can be included in the plastic film to enhance the tear strength and/or increase the softness of the plastic film; however, this is not required.

In still another and/or alternative non-limiting aspect of the present invention, the plastic film can be formed in a variety of ways. In one non-limiting embodiment of the invention, the plastic film is at least partially formed by a mixing process that is used to obtain a generally uniform dispersion of the one or more polymers used to form the plastic film. One or more primary additives (e.g., liquid absorbing material, gas absorbing material, biocide material heat generation material, foaming agent, etc.) that are incorporated in the plastic film can also be added to the one or more polymers during the mixing process and/or be added to the plastic film at a subsequent time during the formation of the plastic film. Generally, the mixing process is designed to form a homogeneous mixture without allowing for agglomeration of the one or more components in the mixture. In one non-limiting aspect of this embodiment, the one or more polymers used to form the plastic film can be dry blended and then passed through an extruder. One or more primary additives that are incorporated in the plastic film can also be dry blended with the one or more polymers prior to extrusion; however, this is not required. In another non-limiting aspect of this embodiment, the one or more polymers used to form the plastic film can be fed to a mixing device (e.g., compounding extruder, high shear continuous mixer, two roll mill or an internal mixer, etc.) and then the mixture is passed through an extruder. One or more primary additives that are incorporated in the plastic film can also be mixed with the one or more polymers prior to extrusion; however, this is not required. In both of the non-limiting processes above, the mixtures of polymer and primary additive, when added, are subjected to sufficient shear and heat to cause the polymers component of the plastic film to at least partially melt. The time and temperature of mixing the mixture is generally controlled to avoid molecular weight degradation of the one or more polymers and/or the one or more primary additives, when used, during the formation of the plastic film. A vacuum drying process can be used in conjunction with the extrusion process to produce the plastic film; however, this is not required. In another and/or alternative non-limiting embodiment of the invention, the plastic film is at least partially formed by a conventional tubular extrusion (blown bubble process), by cast extrusion, or by quenching techniques, all of which are well known in the art. In one non-limiting aspect of this embodiment, the plastic film is at least partially formed by a cast extrusion process. In the cast extrusion process, the molten mixture of one or more polymers and/or the one or more primary additives, when added to the mixture, is extruded from an elongate die in the form of a web. The web is then pressed against a cold roll to chill and solidify the plastic film. An embossed pattern may be imparted on the plastic film utilizing an engraved roll; however, this is not required. The plastic film generally has a thickness of less than about 20 mils, which allows for further stretching, if so desired. As can be appreciated, greater plastic film thickness can be formed. The extrusion temperature, die temperature, and embossing roll temperature, if embossing is used, will generally depend on the composition of the one or more polymers. In one non-limiting set of processing parameters, the melting temperature and die temperatures are about 300-550 EF. In still another and/or alternative non-limiting embodiment of the invention, the plastic film is at least partially formed by a conventional tubular blown film process. In this process, the plastic is initially melted and subsequently extruded through a die. In one non-limiting set of processing parameters, the melting temperature is about 300-580 EF. The melted material is then extruded to form either a bubble or a tube of plastic film. The plastic film is then expanded to the desired dimensions and subsequently cooled by one or more of several conventional techniques (e.g., forced air, mandrel, water quenching, etc.). A positive pressure of a gas (e.g., air, nitrogen, etc.) is maintained inside the tubular bubble of plastic film during the expansion of the plastic film. The expanded plastic film is then flattened. Typically this flattening process is accomplished by passing the film through a collapsing frame and a set of nip rolls; however, this is not required. After the plastic film is flattened, the plastic film can be stretched to obtain the final physical dimensions of the plastic film; however, this is not required. Stretching of the plastic film can be carried out monoaxially in the machine direction or transverse to the machine direction, or can be stretched in both directions (biaxially) either simultaneously or sequentially using conventional equipment and processes. The stretched plastic film can be heated to set and to stabilize the plastic film for any subsequent processing; however, this is not required. When the plastic film is heat set, the plastic film is generally heated to a temperature above the stretching temperature and below the softening temperature of the plastic film. Tension can be maintained on the plastic film during the heat setting and cooling of the plastic film to minimize shrinkback; however, this is not required.

In yet another and/or alternative non-limiting aspect of the present invention, the one or more primary additives (e.g., liquid absorbing material, gas absorbing material, biocide material, heat generation material, foaming agent, etc.) in the plastic film can be present in the plastic film in a variety of ways. In one non-limiting embodiment of the invention, a portion or all of the primary additives are added to the one or more polymers that form the plastic film in a manner to form a generally homogeneous mixture of polymer and primary additive. In another and/or alternative non-limiting embodiment of the invention, a portion or all of the primary additives are added to the plastic film in a manner so that a portion or all of the primary additives in the plastic film are present in a non-homogenous manner throughout the plastic film. The one or more primary additives can be added during the mixing step of the one or more polymers used to form the plastic film and/or added at some time after the polymer mixture has been extruded, laminated, blown, set, cooled and/or stretched. When one or more primary additives are added to the plastic film after the plastic film has been extruded, laminate, blown, set, cooled and/or stretched, the one or more primary additives can be secured to the plastic film in a variety of ways. Non-limiting examples of such processes can include, but are not limited to, heat bonding, adhesives, pressure bonding/embedding, chemical bonding at least partially capturing one or more primary additives between two or more layers of plastic film, etc. As can be appreciated, other or additional processes can be used to secure the one or more primary additives to the plastic film.

In still yet another and/or alternative non-limiting aspect of the present invention, a portion of or all of the one or more primary additives in the plastic film can be fully or partially embedded in the plastic film. In one non-limiting embodiment of the invention, a portion of or all of the one or more primary additives are positioned on the outer surface of the plastic film and/or extend at least partially through an outer surface of the plastic film. In this arrangement, the one or more primary additives are generally more able to readily interact with gases, liquids, organisms, etc. that contact the plastic film. For example, liquid and/or gas absorbing particles and/or molecules located at least partially on the outer surface of the plastic film can directly contact a gas or liquid that contacts the plastic film and rapidly or immediately begin the adsorption of such gas and/or liquid. Likewise, a biocide particle and/or molecule located at least partially on the outer surface of the plastic film can directly contact an organism that contacts the plastic film and rapidly or immediately begin the disinfecting, sanitizing, and/or sterilizing of the organism that contacts the plastic film. In another and/or alternative non-limiting embodiment of the invention, a portion of or all of the one or more primary additives are embedded in the plastic film. In this arrangement, the embedding of the one or more primary additives in the plastic film results in some amount of time delay before the one or more embedded primary additives in the plastic film are able to interact with gases, liquids, organisms, etc. that contact the plastic film. The porosity, permeability and/or thickness of the plastic film will affect the rate that the one or more primary additives interact with gasses, liquids, organisms, etc. that contact the plastic film. These parameters of the plastic film can thus be used to customize and affect the properties of the plastic film. As can be appreciated, the plastic film can include some primary additive that is embedded in the plastic film and some primary additive that is not fully embedded in the plastic film. In such an arrangement, the same or different primary additives can be fully embedded and/or not fully embedded in the plastic film. For example, particular biocide particles and/or molecules may work better when they are at least partially exposed on the outer surface of the plastic film, whereas particular liquid absorbing material may work best when the material is mostly or fully embedded in the plastic film. In such a situation, the plastic film could be designed such that some or all of the biocide is on the outer surface and/or very closely adjacent to the outer surface of the plastic film and that much, if not all, of the liquid absorbing material is embedded in the plastic film. As can be appreciated, this is just one of many non-limiting examples of how different primary additives in the plastic film can be positioned in the plastic film to achieve the desired properties of the plastic film.

In another and/or alternative non-limiting aspect of the present invention, the location of the one or more primary additives in the plastic film can be used to at least partially control the properties of the plastic film. The plastic film can include a generally homogeneous mixture of one or more primary additives, or can include one or more primary additives that are selectively located on the plastic film. When one or more primary additives are selectively positioned on the plastic film, the selective positioning of the one or more primary additives can include, but is not limited to, positioning one or more primary additives on one side of the plastic film, but not on the other side of the plastic film; positioning one or more primary additives in certain patterns/locations on one or both sides of the plastic film; positioning different primary additives in the same or different patterns/locations on one or both sides of the plastic film; creating one or more areas/regions on the plastic film that are absent one or more primary additives; and/or varying the concentration of one or more primary additives on one or both sides of the plastic film and/or along the longitudinal length of the plastic film. As can be appreciated, many different combinations of selective positioning the one or more primary additives on the plastic film can be used. In addition to the above non-limiting combinations set forth above, when the plastic film includes more than one primary additive, one primary additive can be positioned on the plastic film in the same way as one or more other primary additives or be positioned on the plastic film in a different way from one or more other primary additives. When more than one primary additive is included in the plastic film, the concentration of the primary additive can be the same or different from one or more other primary additives. The various possible combinations of primary additive concentration and primary additive location on the plastic film can be used to customize the plastic film for various types of applications.

In still another and/or alternative non-limiting aspect of the present invention, one or more primary additives can be designed to be activated on the plastic film. The activation of one or more primary additives can be accomplished in a variety of ways. Non-limiting examples of activation methods include, but are not limited to, stretching of the plastic film, temperature activation (e.g., increased temperature of the plastic film; decrease temperature of the plastic film, etc.), activation by light and/or by some other electromagnetic wave, activation by exposure to air and/or other type of gas, and/or activation by water and/or other type of liquid. As can be appreciated, other or additional types of activation of the one or more primary additives in the plastic film can be used. The act of activating can be designed to activate all the primary additives on the plastic film, selectively activate some primary additives on the plastic film, and/or activate one or more primary additives in a certain region of the plastic film. In one non-limiting embodiment of the invention, the stretching of the plastic film at least partially activates one or more primary additives in the plastic film in one or more locations on the plastic film. For instance, when the plastic film is packaged in a roll of film, the plastic film is commonly pulled from the roll of film and then cut from the roll. The pulling of the plastic film from the roll and/or cutting the film from the roll typically results in one or more portions of the plastic film being stretched. The stretching of the plastic film can cause one or more regions of the plastic film to become temporarily or permanently thinner. The thinning of the plastic film can be designed to result in one or more primary additives in the region of thinning of the plastic film to become closer to the outer surface of the plastic film and/or to penetrate the outer surface of the plastic film. In addition or alternatively, a film of plastic material or other type of material that is at least partially overlying one or more primary additives can be designed to tear, break or otherwise rupture when the plastic film is stretched, thereby activating the plastic film. As can be appreciated, one or more primary additives in the plastic film can be activated during the manufacturing process. For example, the stretching of the plastic film, the heat setting of the plastic film, and/or the cooling of the plastic can be used to activate one or more primary additives in the plastic film during the manufacturing process. Indeed, the rolling of the plastic film into a roll of film during the packaging process can be used to activate one or more primary additives in the plastic film.

In another and/or alternative non-limiting aspect of the present invention, the plastic film can include one or more perforated areas to enable the plastic film to be easily separated from a roll of plastic film and/or to be formed into desired sizes or shapes. For example, the perforations can be used to enable sheets of the plastic film to be separated from a roll of plastic film, similar to sheets of paper towel being separated from a roll of paper towels. In another and/or additional example, the perforations on the thin film can be used to form desired size sheets and/or shapes so that the sheet of thin film can be customized for a desired location. For instance, different shelves in refrigerators can have a different shape and/or size. The perforations can be used to customize the shape and/or size of the sheet of plastic film to fit on such shelves so that the plastic sheet does not overhang the shelf, or have to be folded before the sheet properly fits on the shelf. When the plastic film is in the form of tiles or mats, the perforations can be used to separate out sections of the plastic film from the larger tile or mat so as to obtain smaller and/or custom sized pieces of the plastic film. For instance, a tile or mat of plastic film may be sized such that it can be broken in half, into quarter sections, etc. so as to allow a user to determine how large of a piece of the tile or mat needs to be used for a certain application. Perforations on the tile or mat can be used to facilitate such separation of one or more portions of the mat or tile for one another. As can be appreciated, other or additional arrangements can be used to facilitate in the separation of one portion of the plastic film from another portion.

In still yet another and/or alternative non-limiting aspect of the present invention, one or more portions of the plastic film can include an indicator. In one non-limiting embodiment of the invention, the one more indicators can be used to inform a user of the time period a plastic film has been in use. This information can be useful to a user, especially when the plastic film includes one or more materials that have a limited life and/or usefulness. For instance, the plastic film can include one or more biocides, liquid absorbing materials and/or gas absorbing materials that have a limited effective life. In another and/or additional example, the plastic film may include a scent generating material to create a fresh scent, and/or some other type of desired scent. After a period of time has passed, the effectiveness of the plastic film to release a particular scent diminishes. In another non-limiting embodiment of the invention, the inclusion of one or more indicators on the plastic film can be used to inform a user that the plastic film needs to be replaced after a certain time of use and/or when one or more features of the plastic film have lost its effectiveness and/or its effectiveness has dropped below some certain level. In still another and/or additional non-limiting embodiment of the invention, the one or more indicators can be used to indicate when one or more portions of the plastic film have performed a particular function and/or cannot continue to function as intended. For example, when a liquid is spilled on the plastic film that includes liquid absorbing materials, the liquid absorbing materials may become fully saturated, and thus be unable to absorb any more liquid. In another or additional example, the plastic film may include gas absorbing materials that cannot absorb any more gas after a period of time. In both of these examples, an indicator can be included on one or more portions of the plastic film to indicate to a user that the plastic film must be replaced since one or more functions of the plastic film cannot further perform its task. The indicator can be located on a portion or all of the plastic film. The indicator can be designed to indicate the location where the plastic film can no longer perform its intended function (e.g., location where liquid has been absorbed on the plastic film and the liquid absorbing materials are saturated and/or saturated beyond some point, location where biocide has become ineffective and/or has reached some level of ineffectiveness, location where gas absorbing materials cannot absorb anymore gas and/or have reached some level of ineffectiveness to absorb gas, etc.); however, this is not required.

In still another and/or alternative non-limiting embodiment of the invention, one or more indicators can be included on the plastic film to inform a user of some environmental status and/or environmental change during the use of the plastic film. For example, one or more indicators can be used to inform the user whether there have been any significant temperature changes or irregularities during the use of the plastic film. For instance, the plastic film can be designed for use in a freezer or refrigerator. The one or more indicators on the plastic film can be used to inform a user that some undesired temperature or temperature change has occurred during use of the plastic film. One non-limiting example of an undesired temperature change could result from the freezer door or refrigerator door not being closed or not properly closed, thereby resulting in a rise in temperature in the freezer or refrigerator. The one or more indicators on the plastic film can be used to inform the user of such an event so the user can take the proper precaution and/or actions with respect to potential spoilage of food and/or food that has potentially become thawed. One non-limiting example of undesired temperature could result from the temperature setting on the refrigerator being set to low or too high, or the temperature setting on the freezer being set too low. The one or more indicators on the plastic film can be used to inform the user that the temperature in the refrigerator is set too cold thus resulting on the unwanted freezing of items in the refrigerator. The one or more indicators on the plastic film can be also or alternatively be used to inform the user that the temperature in the refrigerator is too warm thus resulting in the potential of premature spoilage of food in the refrigerator. The one or more indicators on the plastic film can be used to inform the user that the temperature in the freezer is too warm thus resulting in the improper freezing of food items in the freezer. The one or more indicators on the plastic film can also or alternatively provide other types of environmental information to the user. For instance, one or more indicators can provide a user with information about 1) air quality, 2) presence of certain level of bacteria and/spore and/or fungus, 3) presence of certain types of bacteria and/spore and/or fungus, 4) presence of certain types insects (e.g., ants, roaches, weevils, worms, etc.), 5) humidity levels, etc. A user can then use this information to determine whether food items and/or other items should be disposed of, cleaned, etc.

In yet another and/or alternative non-limiting embodiment of the invention, one or more indicators that are included on the plastic film, when such indicators are used, can include a visual indicator, an audible indicator, and/or a scented indicator. When the indicator is a visual indicator, the visual indicator could be a color indicator that changes color to indicate some progression of time, some period of elapsed time and/or upon the occurrence and/or during the progression of some event or combination of events; however, this is not required. The visual indicator could also or alternatively be a light indicator; however, this is not required. The visual indicator could also be a physical change such as, but not limited to, a pop-up section of the plastic film, etc. The visual indicator could also or alternatively be a meter. The meter could include words, color codes and/or other symbols to indicate some progression of time, some period of elapsed time and/or upon the occurrence and/or during the progression of some event or combination of events; however, this is not required. The indicator could also or alternatively be a sound indicator. The indicator could be designed to create some sound and/or sequence of sounds to indicate some progression of time, some period of elapsed time and/or upon the occurrence and/or during the progression of some event or combination of events; however, this is not required.

In still yet another and/or alternative non-limiting embodiment of the invention, the plastic film can itself be the end use product or the plastic film can be used to form at least part of another product. For instance, the plastic film can be formed such that the plastic film itself is the end product such as a shelf liner, etc. Alternatively, the plastic film can be combined with one or more other materials to form a shelf mat or tile, a floor mat, etc. For example, the plastic film can be combined with one or more layers of plastic film of the same or different type to form a product. Non-limiting examples of such products could include 1) a product that includes at least two layers of plastic film that includes liquid absorbing materials and one or more layers of plastic film that includes gas absorbing materials, 2) a product that includes at least two layers of plastic film that includes liquid absorbing materials, gas absorbing materials and/or biocide and one or more layers of plastic film that includes a different composition relating to the contents of liquid absorbing materials, gas absorbing materials and/or biocide, 3) a product that includes at least two layers of plastic film that includes liquid absorbing materials wherein at least two of the layers include different types of liquid absorbing materials, 4) a product that includes at least two layers of plastic film that includes gas absorbing materials wherein at least two of the layers include different types of gas absorbing materials, 5) a product that includes at least two layers of plastic film that includes biocide wherein at least two of the layers include different types of biocide, and 6) a product that includes at least two layers of plastic film that includes liquid absorbing materials, gas absorbing materials and/or biocide and wherein the polymer composition of at least two of the layers is different. As can be appreciated, the product at least partially formed by the plastic film can also include any combination of examples 1-6 mentioned above. As can also be appreciated, other combinations can exist. In another non-limiting example, one or more layers of plastic film can be combined with materials other than plastic film. For example, one or more layers of plastic film could be secured to a tile or mat that also includes a plastic material, a sponge-type material, a rubber material and/or metal material. In another non-limiting example, one or more layers of plastic film could be secured to a woven or non-woven material. As can be appreciated, there are many examples of applications for the plastic film of the present invention.

In yet another and/or alternative non-limiting aspect of the present invention, there is provided a process for forming a plastic film that includes one or more primary additives wherein the plastic material of the plastic film is deformed about a plurality of particles of one or more primary additives. The deformation about the plurality of particles is achieved in a manner that the bond point between the plastic material in the plastic film and the plurality of particles is created so as to attempt to minimize the bond point surface area and to attempt to maximize the function of the particles of the one or more primary additives without compromising the film structural integrity. For instance, if the plastic film includes particles of a liquid absorbing material and the plastic film is to be designed to have high absorption properties, the bond point between the plastic material and the particles of liquid absorbing material is created to minimize the bond point surface area and to maximize the liquid absorptivity of the particles of liquid absorbing material without compromising the film structural integrity. As can be appreciated, the bond point between the plastic material and the particles of liquid absorbing material can be adjusted to obtain the desired absorbency properties of the plastic film. As can also be appreciated, this concept can be used for other or additional types of primary additives in the plastic film. In one non-limiting embodiment of the invention, the plastic material in the plastic film can be at least partially controllably deformed over a plurality of particles of one or more primary additives by at least partially controlling the temperature of the plastic film as the plastic film is moved over a plurality of particles. The temperature of the plastic film is controlled to control the amount of softening of the plastic film. During the movement of the plastic film over the particles, the plastic film will deform and thereby at least partially adhere to and release from the particles until the tension on the softened plastic film comes to dynamic equilibrium to form a stable bond point with the solid particles. In one non-limiting aspect of this embodiment, tension, pressure and/or heat can be applied to the plastic film so as to at least partially control the film bond point surface area between the plurality of particles and the plastic material. The pressure can be applied to the top and/or bottom of the plastic film so as to promote the deformation of the plastic. The tension and pressure applied to the plastic should be controlled so as to not cause the destruction of the bond between the particles and the plastic material. The pressure should also be controlled so as to not cause significant damage or destruction to the particles of primary additive. The hardness of the particles of primary additive used in the plastic film is generally at least about 3 on the Mohr scale, and more typically at least about 4 on the Mohr scale. The particles generally have an average particle size of less than about 60 microns, typically about 0.5-30 microns, and more typically about 1-10 microns. In some applications, the particle size may be larger or smaller. The temperature applied to the plastic film also should not be too high so as to overly soften and/or degrade the plastic material and/or particles of primary additive in the plastic film. The temperature is also controlled to obtain the desired hardness and durability of the plastic film. In one non-limiting example, the process parameters for forming the plastic film are softening the plastic film at a temperature of about 100-250 EF, and typically about 110-200 EF, and even more typically about 120-180 EF, at a pressure that is applied to one or more sides of the plastic film of about 20-200 Epsi, and typically about 50-150 psi, and more typically about 90-110 psi. As can be appreciated, different temperatures, tensions, and/or pressures can be used depending on the type of plastic material used in the plastic film, the thickness of the plastic film, the hardness of primary additive particles used in the plastic film, and/or the primary additive used in the plastic film. In another and/or alternative non-limiting embodiment of the invention, the plastic film can be subjected to pressure on one or both sides of the plastic film, and/or be subjected to the softening temperature by a variety of arrangements. Non-limiting arrangements include pulling the film over a heated or non-heated roller, pulling the plastic film along a heated plate while another plate, roller or other type of device applies pressure to the plastic film as the plastic film moves along the heated plate. The other plate, roller or other type of device that applies pressure may or may not be heated. In certain applications, when the plastic film is pulled over a roller, a high curvature angle (e.g., greater than 30 E) of the plastic film over the roller can promote increased exposure of particles of the one or more primary additives at the outer surface of the plastic film. In one non-limiting arrangement, the curvature angle of the plastic film being drawn about the roller is at least about 45 E, typically at least about 90 E, and more typically at least about 110 E.

In still yet another and/or alternative non-limiting aspect of the present invention, there is provided a process for forming a plastic film that includes blending together polymer and particles of at least one primary additive in a master mixed batch, and then melting and extruding the melted mixture through one or more types of shape forming dies so as to cause bond points between the particles of the one or more primary additives and the plastic material of the plastic film to be created. The melt temperature, flow properties and/or the crystallization versus time curve as the extruded mixture is being formed is controlled so as to obtain the desired properties of the plastic film.

In still yet another and/or alternative non-limiting aspect of the present invention, there is provided a mat, tile or pouch that can be used to at least partially absorb one or more liquids and/or gases, and/or to at least partially disinfect, sanitize, and/or sterilize one or more organisms and/or materials that come in contact with the mat, tile or pouch. The mat, tile or pouch is also designed to have sufficient integrity retention so as to resist degradation of the integrity of the mat, tile or pouch when one or more liquids and/or gases are spilled or otherwise come in contact with the tile, mat or pouch, and/or when the tile, mat or pouch at least partially absorbs one or more liquids and/or gases that come in contact with the tile, mat or pouch. The tile, mat or pouch can be used in a variety of applications such as, but not limited to, shelf liners (e.g., refrigerator shelves, pantry shelves, dish and/or glassware shelves, linen shelves, utility and/or storage shelves, etc.), toilet seat covers, counter top liners, floor covers, microwave liners, document holders and/or protectors, book covers and/or protectors, picture covers and/or protectors, storage bags, bottle covers or sleeves, glass ware covers or sleeves, container covers or sleeves, etc. In essence, the tile, mat, or pouch can potentially be used in almost any application that requires the protection of one or more surfaces and/or materials from liquids, undesired gases, and/or undesired organisms. One non-limiting application for the mat or tile is a shelf liner for use on a refrigerator shelf, a freezer shelf, a pantry shelf, and/or a clothing drawer or shelf. The tile or mat in the form of a shelf liner can be design so that food items, dishware, glassware, silverware can be placed on the tile or mat so as to protect the surface underneath the tile or mat from moisture and/or other types of materials, and/or other types of contact with the surface that could damage or deface the surface. In one non-limiting application, the pouch can be designed to fit partially or fully about a bottle, can and/or other type of container. For example when a cold beverage is removed from a refrigerator or the like, the can, bottle or container for the beverage begins to sweat, and thereby causes water to form about the base of the can, bottle or container. The pouch can be used to absorb the water that forms on the side of the can, bottle or container thereby inhibiting or preventing the water from contacting a surface that could be damaged and/or defaced from the water. As can be appreciated, the tile, mat or pouch can have other applications not listed above (e.g., warming tiles or mats, warming pouches, etc.). The thickness of the tile, mat or pouch and/or the composition of the tile, mat or pouch can be selected to achieve certain desired properties for the tile, mat or pouch (e.g., durability, flexibility, melting point, microwave safe, formability, stretchability, chemical resistant properties, gas permeability properties, temperature resistant properties, clinging properties, gripping properties, etc.). The composition of the tile, mat or pouch is selected to maintain its desired function in one or more environments (e.g., freezer, refrigerator, inside ambient environments, outside ambient environments, etc.). In one non-limiting example, the tile, mat or pouch can be designed for use in both a freezer and refrigerator environment. In another and/or additional non-limiting example, the tile, mat or pouch can be designed for use in a microwave. The tile, mat or pouch can have any number of shapes, sizes, thicknesses. For instance, the tile or mat, when designed for use as shelf liner for a refrigerator shelf and/or a pantry shelf, generally has a maximum thickness of about one inch, and typically about 0.1-0.5 inch; however, other thicknesses can be used. The thickness of the tile or mat, when designed for use as shelf liner for a refrigerator shelf and/or a pantry shelf, can be generally uniform; however, this is not required. The tile or mat, when designed for use as shelf liner for a refrigerator shelf and/or a pantry shelf, can have a certain shape (e.g., square shaped, rectangular shaped, etc.) and/or a certain size to fit on various sized shelves. The tile or mat, when designed for use as shelf liner for a refrigerator shelf and/or a pantry shelf, is generally flexible; however, the tile or mat can be made to be generally rigid.

In another and/or alternative non-limiting aspect of the present invention, the tile, mat or pouch can include one or more primary additives. Such primary additives can include, but are not limited to, a liquid absorbing material, gas absorbing material, biocide, and/or heat generating material. The liquid absorbing material, when included in the tile, mat or pouch, is selected to at least partially absorb one or more liquids that contact the tile, mat or pouch. Many different types of liquid absorbing materials can be used in the tile, mat or pouch. Non-limiting examples of such liquid absorbing materials can include the same or similar materials as previously identified with regard to liquid absorbing materials that can be included in the plastic film. The amount of the liquid absorbing material in the tile, mat or pouch is selected to obtain the desired amount of absorbency of the tile, mat or pouch. The amount of the liquid absorbing material in the tile, mat or pouch is also selected so as to not adversely affect the integrity of the tile, mat or pouch after liquids have contacted and have been at least partially absorbed by the tile, mat or pouch; however, this is not required. In one non-limiting embodiment of the invention, the tile, mat or pouch can include up to 99 weight percent liquid absorbing material. In one non-limiting aspect of this embodiment, the tile, mat or pouch includes about 1-90 weight percent liquid absorbing material, and typically about 2-80 weight percent liquid absorbing material. As can be appreciated, other weight percentages can be used. The gas absorbing material, when used in the tile, mat or pouch, is selected to at least partially absorb one or more gases that contact the tile, mat or pouch. The absorption of one or more gases by the tile, mat or pouch can be used to reduce or eliminate odors, and/or protect materials from various types of gases. As can be appreciated, there can be other or additional uses for the gas absorbing material in the tile, mat or pouch. Many different types of materials can be used to absorb one or more gases. Non-limiting examples of such gas absorbing materials can include the same or similar materials as previously identified with regard to liquid absorbing materials that can be included in the plastic film. The amount of the gas absorbing material in the tile, mat or pouch is selected to obtain the desired about of gas absorbency of the tile, mat or pouch. The amount of the gas absorbing material in the tile, mat or pouch is also selected so as to not adversely affect the integrity of the tile, mat or pouch, and/or the integrity of the tile, mat or pouch after gases have contacted and have been at least partially absorbed by the tile, mat or pouch; however, this is not required. In one non-limiting embodiment of the invention, the tile, mat or pouch includes no more than about 90 weight percent gas absorbing material. In one non-limiting aspect of this embodiment, the tile, mat or pouch includes about 1-70 weight percent gas absorbing material, and typically about 2-65 weight percent gas absorbing material. As can be appreciated, other weight percentages can be used. Biocide, when used in the tile, mat or pouch, is selected to at least partially inhibit, prevent, reduce or eliminate the growth of one or more undesirable organisms (e.g., bacteria, fungus, viruses, insects, etc.) that contact and/or are in close proximity to the tile, mat or pouch. The prevention or elimination of one or more organisms on and/or about the tile, mat or pouch can be used to at least partially disinfect, sanitize, and/or sterilize regions on and/or about the tile, mat or pouch. Many different types of biocides can be used in the tile, mat or pouch. Non-limiting examples of such biocides can include the same or similar materials as previously identified with regard to biocides that can be included in the plastic film. The amount of biocide in the tile, mat or pouch is selected to obtain the desired amount of organism prevention and/or protection by the tile, mat or pouch. The amount of the biocide in the tile, mat or pouch is also selected so as to not adversely affect the integrity of the tile, mat or pouch. In one non-limiting embodiment of the invention, the tile, mat or pouch includes no more than about 75 weight percent biocide. In one non-limiting aspect of this embodiment, the tile, mat or pouch includes about 1-70 weight percent biocide, and typically about 2-65 weight percent biocide. As can be appreciated, other weight percentages can be used. The heat generating material, when used in the tile, mat or pouch, is selected to at least partially generate heat when the heat generating material comes in contact with a fluid such as, but not limited to, water, oxygen, etc. The generation of heat by the tile, mat or pouch can be used to warm and/or defrost cold items, provide heat in cold environments, etc. As can be appreciated, other or additional applications of the heat generating material in the tile, mat or pouch can be used. Many different types of heat generating materials can be used in the tile, mat or pouch. Non-limiting examples of such heat generating materials can include the same or similar materials as previously identified with regard to heat generating material that can be included in the plastic film. The amount of the heat generating material in the tile, mat or pouch is selected to obtain the desired amount of heat generation by the tile, mat or pouch. The amount of the heat generating material in the tile, mat or pouch is also selected so as to not adversely affect the integrity of the tile, mat or pouch, and/or to not adversely affect the integrity of the tile, mat or pouch after the heat generating material has contacted a fluid and has been generating heat in the tile, mat or pouch; however, this is not required. In one non-limiting embodiment of the invention, the tile, mat or pouch includes no more than about 75 weight percent heat generating material. In one non-limiting aspect of this embodiment, the tile, mat or pouch includes about 1-70 weight percent heat generating material, and typically about 2-65 weight percent heat generating material. As can be appreciated, other weight percentages can be used. The tile, mat or pouch can include a plurality of different materials that can perform different functions. For example, the tile, mat or pouch can include any combination of a liquid absorbing material, a gas absorbing material, biocide material, and heat generating material. As such, the tile, mat or pouch can include two or more different primary additives to enable the tile, mat or pouch to have multiple features. The tile, mat or pouch can also include other materials to enhance or affect one or more properties of the tile, mat or pouch; however, this is not required.

In another and/or alternative non-limiting aspect of the present invention, the tile, mat or pouch can be formed of one or more layers and/or one or more different materials. The materials that can be used to form the tile, mat or pouch can include a variety of materials such as, but not limited to, polymer materials (e.g., plastics, cellulose, synthetic fibers [e.g., nylon, polyester, etc.], etc.), natural fibers (e.g., cotton, etc.), resin materials, wood, metal, glass, composite materials, etc. When fiber materials are used, the fibers can be woven and/or non-woven fibers. In one non-limiting embodiment of the invention, the tile, mat or pouch includes one layer of material that includes one or more primary additives. In another and/or alternative non-limiting embodiment of the invention, the tile, mat or pouch includes a plurality of layers. The layers can be made of the same or different material. The layers can contain the same or different primary additives. One or more layers can include one or more primary additives and one or more layers can be absent primary additives. The size, shape and/or thickness of each layer can be the same or different. In one non-limiting example, the tile, mat or pouch includes two layers, and at least one layer includes a primary additive that is not included in the other layer. In another one non-limiting example, the tile, mat or pouch includes top, middle and bottom layers, and the top layer includes a primary additive that is not included in the bottom layer, and the middle layer is formed of a material that is substantially impenetrable to liquids (e.g., water, milk, fruit juices, soda, etc.).

In another and/or alternative non-limiting aspect of the present invention, the tile, mat or pouch can include one or more perforated areas to enable the tile, mat or pouch to be easily separated from a roll of tiles, mats or pouches; or be separated from a larger tile, mat or pouch configuration that includes a plurality of tiles, mats or pouches; and/or to enable the tile, mat or pouch to be formed into desired sizes or shapes. For example, the perforations can be used to enable a tile, mat or pouch to be separated from a roll of tiles, mats or pouches. In another and/or additional example, the perforations can be used to form desired sized and/or shaped tiles, mats or pouches so that the tile, mat or pouch can be customized for a desired location. For instance, different shelves in refrigerators can have a different shape and/or size. The perforations can be used to customize the shape and/or size of the tile or mat to fit on such shelves so that the tile or mat does not overhang the shelf, or have to be folded before the tile or mat fits on the shelf. The perforations can be used to separate out smaller tiles or mats from a larger tile or mat so as to obtain smaller and/or custom sized tiles or mats. For instance, a larger tile or mat may be sized and designed such that it can be broken in half, into quarter sections, etc. so as to allow a user to determine how large of the piece of the tile or mat needs to be used for a certain application. Perforations on the tile or mat can be used to facilitate such separation of one or more portions of the mat or tile from one another.

In still yet another and/or alternative non-limiting aspect of the present invention, one or more portions of the tile, mat or pouch can include an indicator. In one non-limiting embodiment, of the invention, the one or more indicators can be used to inform a user of the time period a tile, mat or pouch has been in use. This information can be useful to a user, especially when the tile, mat or pouch includes one or more materials that have a limited life and/or usefulness. For instance, the tile, mat or pouch can include one or more biocides, liquid absorbing materials and/or gas absorbing materials that have a limited effective life. In another and/or additional example, the tile, mat or pouch may include a scent generating material to create a fresh scent, and/or some other type of desired scent. After a period of time has passed, the effectiveness of the tile, mat or pouch to release a particular scent diminishes. In another non-limiting embodiment of the invention, the inclusion of one or more indicators on the tile, mat or pouch can be used to inform a user that the tile, mat or pouch needs to be replaced after a certain time of use and/or one or more features of the tile, mat or pouch have lost its effectiveness and/or when its effectiveness has dropped below some certain level. In still another and/or additional non-limiting embodiment of the invention, the one or more indicators can be used to indicate when one or more portions of the tile, mat or pouch have performed a particular function and/or cannot continue to function as intended. For example, when a liquid is spilled on the tile, mat or pouch that includes liquid absorbing materials, the liquid absorbing materials may become fully saturated, thus be unable to absorb any more liquid. In another or additional example, the tile, mat or pouch may include gas absorbing materials that cannot absorb any more gas after a period of time. In both of these examples, an indicator can be included on one or more portions of the tile, mat or pouch to indicate to a user that the tile, mat or pouch must be replaced since one or more functions of the tile, mat or pouch cannot further perform its task. The indicator can be located on a portion or all of the tile, mat or pouch. The indicator can be designed to indicate the location where the tile, mat or pouch can no longer perform its intended function (e.g., location where liquid has been absorbed on the tile, mat or pouch and the liquid absorbing materials are saturated and/or saturated beyond some point, location where biocide has become ineffective and/or has reached some level of ineffectiveness, location where gas absorbing materials cannot absorb anymore gas and/or has reach some level of ineffectiveness to absorb gas, etc.); however, this is not required.

In still another and/or alternative non-limiting embodiment of the invention, one or more indicators can be included on the tile, mat or pouch to inform a user of some environmental status and/or environmental change during the use of the tile, mat or pouch. For example, one or more indicators can be used to inform the user whether there have been any significant temperature changes or irregularities during the use of the tile, mat or pouch. For instance, the tile, mat or pouch can be designed for use in a freezer or refrigerator. The one or more indicators on the tile, mat or pouch can be used to inform a user that some undesired temperature or temperature change has occurred during use of the tile, mat or pouch. One non-limiting example of an undesired temperature change could result from the freezer door or refrigerator door not being closed or properly closed, thereby resulting in a rise in temperature in the freezer or refrigerator. The one or more indicators on the tile, mat or pouch can be used to inform the user of such an event so the user can take the proper precaution and/or actions with respect to potential spoilage of food and/or food that has potentially become thawed. In one non-limiting example of an undesired temperature could result from the temperature setting on the refrigerator being set too low or too high, or the temperature setting on the freezer being set too low. The one or more indicators on the tile, mat or pouch can be used to inform the user that the temperature in the refrigerator is set too cold thus resulting in the unwanted freezing of items in the refrigerator. The one or more indicators on the tile, mat or pouch can be also or alternatively used to inform the user that the temperature in the refrigerator is too warm thus resulting in the potential of premature spoilage of food in the refrigerator. The one or more indicators on the tile, mat or pouch can be used to inform the user that the temperature in the freezer is too warm thus resulting in the improper freezing of food items in the freezer. The one or more indicators on the tile, mat or pouch can also or alternatively provide other types of environmental information to the user. For instance, one or more indicators can provide a user with information about 1) air quality, 2) presence of certain level of bacteria and/spore and/or fungus, 3) presence of certain types of bacteria and/spore and/or fungus, 4) presence of certain types in insects, 5) humidity levels, etc. A user can then use this information to determine whether food items and/or other items should be disposed of, cleaned, etc. The indicator can also be used to inform a user which side should be placed on a surface (i.e., shelf surface, etc.) and/or which side should be facing upward.

In yet another and/or alternative non-limiting embodiment of the invention, one or more indicators that are included on the tile, mat or pouch, when such indicators are used, can include a visual indicator, an audible indicator, and/or a scented indicator. When the indicator is a visual indicator, the visual indicator could be a color indicator that changes color to indicate some progression of time, some period of elapsed time and/or upon the occurrence and/or during the progression of some event or combination of events; however, this is not required. The visual indicator could also or alternatively be a light indicator; however, this is not required. The visual indicator could also be a physical change such as, but not limited to, a pop-up section of the tile, mat or pouch, etc. The visual indicator could also or alternatively be a meter. The meter could include words, color codes and/or other symbols to indicate some progression of time, some period of elapsed time and/or upon the occurrence and/or during the progression of some event or combination of events; however, this is not required. The visual indicator could also or alternatively be a light indicator; however, this is not required. The indicator could also or alternatively be a sound indicator. The indicator could be designed to create some sound and/or sequence of sounds to indicate some progression of time, some period of elapsed time and/or upon the occurrence and/or during the progression of some event or combination of events; however, this is not required.

One non-limiting object of the present invention is to provide an improved plastic film and method and process for making the improved plastic film.

Another and/or alternative non-limiting object of the present invention is to provide an improved plastic film that includes one or more absorbent materials, biocides, heat generating materials, and/or foaming materials.

Still another and/or alternative non-limiting object of the present invention is to provide an improved plastic film that includes one or more primary additives that are at least partially exposed on an outer surface of the plastic film.

Yet another and/or alternative non-limiting object of the present invention is to provide an improved plastic film that includes one or more primary additives that are at least partially embedded in the plastic film.

Still yet another and/or alternative non-limiting object of the present invention is to provide a product that includes two or more layers of an improved plastic film wherein at least one layer of plastic film includes one or more primary additives.

Another and/or alternative non-limiting object of the present invention is to provide a product that includes a plurality of different materials wherein one material includes an improved plastic film that includes one or more primary additives.

Still another and/or alternative non-limiting object of the present invention is to provide a plastic film that includes one or more perforations to enable the plastic film to be customized as to the shape and/or size of the plastic film.

Yet another and/or alternative non-limiting object of the present invention is to provide a tile, mat or pouch that includes one or more absorbent materials, biocides, heat generating materials, and/or foaming materials.

Still yet another and/or alternative non-limiting object of the present invention is to provide a tile, mat or pouch that includes two or more layers wherein at least one layer includes one or more primary additives.

Another and/or alternative non-limiting object of the present invention is to provide a tile, mat or pouch that includes one or more perforations to enable the tile, mat or pouch to be customized as to the shape and/or size of the tile, mat or pouch.

These and other objects and advantages will become apparent to those skilled in the art upon reading and following the description of the invention taken together with the accompanied drawings.

### BRIEF DESCRIPTION OF THE DRAWINGS

Reference may now be made to the drawings, which illustrates various non-limiting attributes of the invention wherein;

FIG. 1 illustrates a cross-section of a portion of a plastic film formed of two layers of plastic and particles of at least one type of primary additive therebetween;

FIG. 2 illustrates a cross-section of a portion of a plastic film similar to FIG. 1 except that the particles are at least partially embedded in one of the plastic layers;

FIG. 3 illustrates a cross-section of a portion of plastic film formed of a single layer of plastic and particles of at least one type of primary additive partially embedded in the plastic layer;

FIG. 4 illustrates a cross-section of a plastic film formed of a single layer of plastic and particles of at least one type of primary additive fully embedded in the plastic layer;

FIG. 5 illustrates a cross-section of a plastic film similar to FIG. 2 except that the particles are extending through the top plastic layer;

FIG. 6 illustrates a cross-section of a plastic film similar to FIG. 2 except that the particles are extending through both of the plastic layers;

FIG. 7 illustrates a cross-section of a plastic film similar FIG. 3 except that the particles extend through both sides of the single layer of plastic;

FIG. 8 illustrates a cross-section of a plastic film similar to FIG. 2 except that the top layer of plastic has a reduced thickness over the particles;

FIG. 9 illustrates a cross-section of a plastic film similar to FIG. 4 except that the layer of plastic has a reduced thickness over both side the particles;

FIG. 10 illustrates a tile, mat or pouch that has a single layer and including one or more primary additives;

FIG. 11 illustrates a tile, mat or pouch that has two layers and including one or more primary additives in each layer;

FIG. 12 illustrates a tile, mat or pouch that has three layers and including one or more primary additives in the top and bottom layer;

FIG. 13 illustrates a larger tile or mat that can be separated into smaller tiles or mats; and,

FIG. 14 illustrates a roll of a plastic film, tile or mat that can be separated into individual sheets of plastic film or individual tiles or mats.

### DESCRIPTION OF THE INVENTION

Referring now to the drawings wherein the showing is for the purpose of illustrating preferred embodiments of the invention only and not for the purpose of limiting the same, FIGS. 1-9 disclose several non-limiting examples of plastic film that includes one or more types of primary additives. The plastic film of the present invention represents a significant improvement over prior art plastic films. The plastic film includes one or more primary additives in the form of a liquid absorbing material, a gas absorbing material, a biocide, a heat generating agent and/or a foaming agent. The plastic film may also include other types of secondary additives such as, but not limited to, coloring agents, scented agents, stabilizers, antistatic agents, anti-sticking agents, pH adjusters, UV protectors, sequestration agents, elastomers, etc.

The plastic film of the present invention has many different potential applications depending on the type of primary additives included in the plastic film. For purposes of illustration only, the plastic film in FIGS. 1-9 will be described with specific reference to a plastic film that is used as a liner for a shelf of a refrigerator; however, it will be appreciated that the plastic film can have many other uses and such other uses are contemplated and covered by the present invention. Also, the plastic film in FIGS. 1-9 will be described with specific reference to a plastic film that includes a liquid absorbing agent, a gas absorbing agent, and/or a biocide; however, it will be appreciated that the plastic film can include other or additional primary additives. Indeed, any combination of liquid absorbing material, a gas absorbing material, biocide, heat generating agent and/or a foaming agent can be included in the plastic film and all such combinations are contemplated and covered by the present invention.

Referring now to FIGS. 1, 2, 5, 6 and 8, there is illustrated a plastic film 20 that is formed from two plastic layers 30, 40. As can be appreciated, the plastic film can be formed of more than two plastic layers. The two plastic layers can be formed of the same material or different materials. The two plastic layers can have the same general thickness or different thicknesses. The thickness of one or both layers can be generally uniform or can vary along the longitudinal length of each plastic layer. Generally, the plastic layers are formed from a linear low density polyethylene, a high density polyethylene, polypropylene, polyamide, polyester, or some mixtures thereof. When the plastic film 20 is in the form of a thin stretchable film, one or both of the plastic layers is generally formed of a linear low density polyethylene that includes interpolymerized comonomers having ethylene and at least one ∀-olefin containing from 3 to 18 carbon atoms, and having a density of about 0.9-0.96 g/cm³, and also having a melting point of about 225-425 EF. The thickness of each plastic layer is generally less than about 10 mils and the total thickness of the plastic film 20 is generally less than about 20 mils. The thickness of the plastic film will generally depend on the designed use of the plastic film. For shelf liner applications, the plastic film thickness is generally about 3-7 mils. The plastic layers 30, 40 are typically clear transparent or semi-transparent layers; however, it can be appreciated that one or both plastic layers can be colored and/or be non-transparent. As can also be appreciated, the color and/or degree of transparency of each layer can be the same or different. The color and degree of transparency of each plastic layer for the plastic film 20 will generally depend on the designed use of the plastic film. Each layer of plastic 30, 40 is illustrated as having a generally smooth outer surface; however, it can be appreciated that one or both plastic layers can have a non-smooth outer surface.

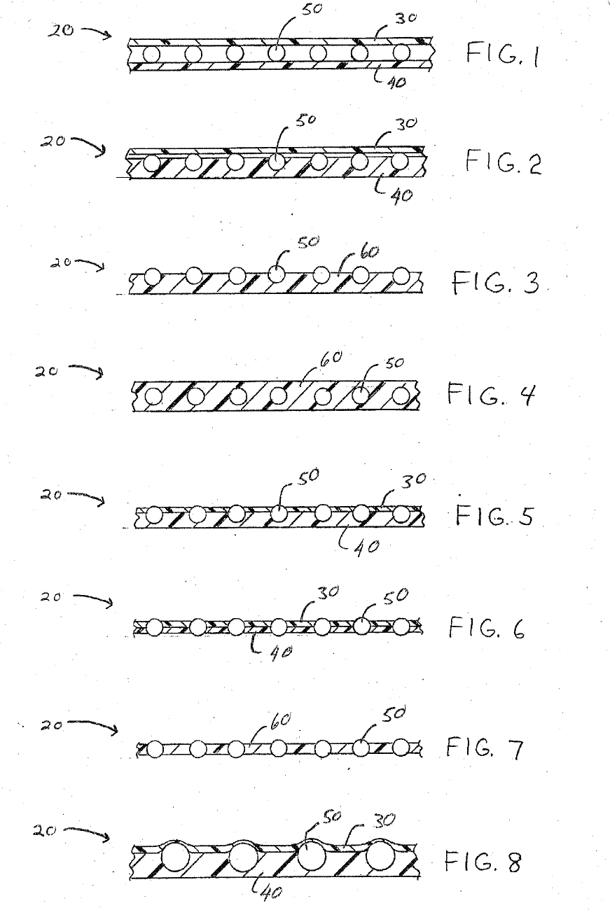

Referring now to FIGS. 3, 4, 7, and 9, there is illustrated a plastic film 20 that is formed from a single plastic layer 60. The composition and properties of the plastic layer 60 can be the same as the properties of the plastic layers 30, 40 as discussed above with respect to FIGS. 1, 2, 5, 6 and 8.

Referring now to FIGS. 1-9, the plastic film 20 includes a plurality of particles 50 of one or more types of primary additives. The particles of primary additive as represented in the figures are generally spherically shaped particles and have a generally uniform size. As can be appreciated, particles 50 can have non-spherical shapes and/or the particle size distribution can vary. The average particle size for the particles of primary additive in the plastic film is generally less than about 40 microns, and typically about 1-8 microns. The plastic film can include one or more types of primary additives. Each type of primary additive included in the plastic film can be of one type of material or a plurality of different materials. For instance, when the plastic film includes a liquid absorbing agent, the liquid absorbing agent can be in the form of particles of only sodium bentonite, or be formed of particles of two different materials such as sodium bentonite and sodium polyacrylate. When different materials are used, the shape and size of the particles of the different materials can be the same or different. The particles 50 also generally have a minimum hardness to enable the particles to at least partially maintain their integrity during the plastic film forming process which will be discussed in more detail below. Generally, the particles have an average hardness of at least about 2 Mohr, and more typically a hardness of at least about 3 Mohr. In some applications, the hardness of some or all of the particles can be less than about 2 Mohr. When more than one type of material forming the particles is included in the plastic film, the particles can have the same or different hardness. Although not shown in the figures, at least a portion of the primary additive can be in a form that does not have a separate particle form, thus is incorporated into one or more of the plastic layers of the plastic film. The concentration of one or more primary additives in the plastic film can vary depending on the composition of the primary additive and the effectiveness of the primary additive. Typically each primary additive constitutes less than about 65 weight percent of the plastic film, and typically about 1.5-40 weight percent of the plastic film. When a two of more primary additives are included in the plastic film, the combined amount of primary additive in the plastic film is no more than about 70 weight percent of the plastic film, and typically about 3-65 weight percent of the plastic film.

Referring now to FIG. 1, plastic film 20 includes two plastic layers 30, 40 and a plurality of particles 50. As can be appreciated, the plastic film can include three or more layers of plastic and have particles at least partially positioned between two or more layers of plastic. As shown in FIG. 1, a gap exists between the two plastic layers, however, this is primarily for illustration purposes only. In practice, the two plastic layers contact one another in multiple locations on the plastic film. The two plastic layers are shown to have generally the same thickness; however, this is not required. Particles 50 are shown to be substantially encapsulated between the two plastic layers. In this non-limiting arrangement for the plastic film, one or both of the plastic layers are porous and/or permeable to enable the particles to interact with liquids, gases, microorganisms, etc. that come in contact with the outer surface of one or both of the plastic layers. The thickness of one or both of the layers can be used to control the rate at which the particles interact with liquid, gases, microorganism, etc. that come in contact with the outer surface of one or both of the plastic layers; however, this is not required. In one non-limiting use of the plastic film, plastic film 20 is used as a liner for a shelf in a refrigerator. In such an application, particles 50 in the plastic film can include a liquid absorbing agent (e.g., sodium bentonite, sodium polyacrylate, etc.). When one or more liquids (e.g., water, milk, soda, fruit juice, etc.) contact the outer surface of the liner, one or both of the plastic layers 30, 40 allow the liquid to permeate the plastic layer until the liquid contacts one or more liquid absorbing particles. The liquid absorbing particles in the liner absorb the liquid at least partially into the liner. The liquid absorbing particles can be designed to expand when absorbing a liquid. The expansion of one or more particles can result in the particles penetrating the outer surface of one or both plastic films, thereby enabling the particles to directly contact the liquid and potentially absorb the liquid at a faster rate; however, this is not required. If the liquid absorbing particles are designed to expand and penetrate the outer surface of one or both plastic layers, the plastic layers and particles are typically selected so as to maintain the integrity of the plastic film when liquid is absorbed by the plastic film; however, this is not required. The liner can also include a biocide (e.g., calcium hypochlorite, dichloroisocyanuratic salt, etc.); however, this is not required. The biocide, when used, can inhibit or prevent the growth of microorganisms (e.g., mold, bacteria, etc.) on the plastic film. Liquids that are on the plastic film and/or absorbed into the plastic film can become a breading ground for unwanted microorganisms. The biocide in the plastic film can be used to inhibit or prevent the growth of such unwanted microorganisms. As such, the liner can perform the dual purpose of absorbing liquids on a refrigerator shelf so as to reduce the incidence of damage to other foods and/or food packaging by the liquid, and can also inhibit or prevent the growth of unwanted microorganisms that can also damage foods in the refrigerator and/or produce undesired odors. As can be appreciated, the liner can include a gas absorbing material (e.g., activated carbon, sodium bicarbonate, etc.) as an alternative to the biocide or in addition to the biocide; however, this is not required. The gas absorbing material can be used to reduce or eliminate undesired odors in the refrigerator. The material used to form the liquid absorbing material, the gas absorbing material and/or the biocide can be the same or different. Typically, when two types of primary additives are used in the plastic film, at least two different materials for the primary additives are used; however, this is not required.

Referring now to FIG. 2, plastic film 20 includes two plastic layers 30, 40 and a plurality of particles 50. As can be appreciated, the plastic film can include three or more layers of plastic and have particles at least partially positioned between two or more layers of plastic. As shown in FIG. 1, a gap exists between the two plastic layers, however, this is primarily for illustration purposes only. In practice, the two plastic layers contact one another in multiple locations on the plastic film. The two plastic layers are shown to have different thicknesses; however, this is not required. Particles 50 are shown to be substantially encapsulated between the two plastic layers. Particles 50 are also shown to be partially embedded in plastic layer 40. In this non-limiting arrangement for the plastic film, one or both of the plastic layers are porous and/or permeable to enable the particles to interact with liquid, gases, microorganism, etc. that come in contact with the outer surface of one or both of the plastic layers. The thickness of one or both of the layers can be used to control the rate at which the particles interact with liquids, gases, microorganisms, etc. that come in contact with the outer surface of one or both of the plastic layers; however, this is not required. Plastic layer 40 can be designed as an imperturbable layer or a permeable layer that enables the particles to interact with liquids, gases, microorganism, etc. that come in contact with the outer surface of plastic layer 40. The thinness of plastic layer 30 can also be used to enable one or more particles to penetrate through layer 30, especially when the particles are designed to absorb a liquid/gas and expand during such absorption. The ease at which plastic layer 30 enables penetration by the particle can facilitate in maintaining the integrity of the plastic film; however, this is not required. The plastic film illustrated in FIG. 2 can be used as a liner for a shelf of a refrigerator and function similar to the plastic film illustrated in FIG. 1, and can also include the same or similar primary additives as discussed with reference to the plastic film illustrated in FIG. 1.

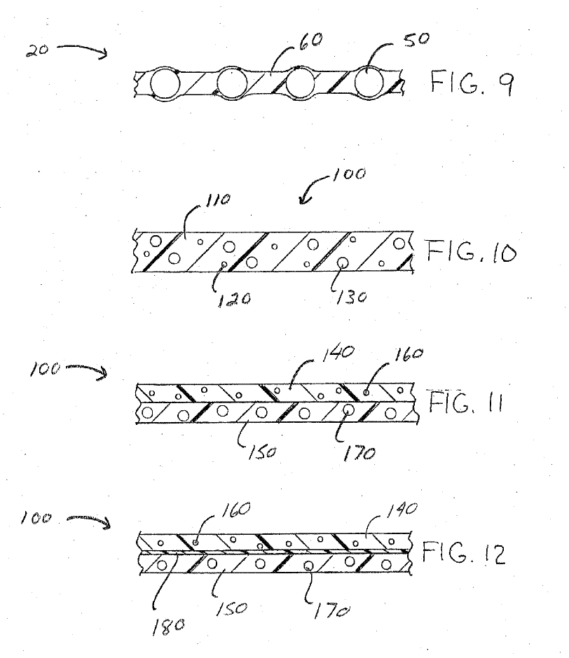

Referring now to FIG. 5, plastic film 20 includes two plastic layers 30, 40 and a plurality of particles 50. As can be appreciated, the plastic film can include three or more layers of plastic and have particles at least partially positioned between two or more layers of plastic. As shown in FIG. 5, the two plastic layers contact one another; however, the two plastic layers can be merely contacting one another in multiple locations on the plastic film. The two plastic layers are shown to have different thicknesses; however, this is not required. Particles 50 are shown to be partially embedded in plastic layer 40. A portion of particles 50 is also shown to pass through plastic layer 30 such that the particles penetrate the outer surface of one side of the plastic film. In this non-limiting arrangement for the plastic film, one or both of the plastic layers may be porous and/or permeable; however, this is not required. The thickness of one or both of the layers can be used to control the rate at which the particles interact with liquids, gases, microorganism, etc. that come in contact with the outer surface of one or both of the plastic layers; however, this is not required. The exposure of a portion of particles 50 on one outer surface of the plastic film enables the particles to directly contact liquids, gases, microorganism, etc. that come in contact with the outer surface of plastic layer 30. Such direct interaction between the particles and a liquid, gas, microorganism, etc. that come in contact with the particle can result in an increased rate at which the particles achieve their designed function; however, this is not required. The exposure of the particles through plastic layer 30 can also be used to maintain the integrity of the plastic film. When one or more of the particles are designed to absorb a liquid/gas and expand during such absorption, the particle can be designed to expand outwardly from the outer surface of the plastic layer, thereby reducing stresses between the particle and plastic layer; however, this is not required. Plastic layer 40 can be designed as an imperturbable layer or a permeable layer that enable the particles to interact with liquids, gasses, microorganism, etc. that come in contact with the outer surface of plastic layer 40. The plastic film illustrated in FIG. 5 can be used as a liner for a shelf of a refrigerator and function similar to the plastic film illustrated in FIG. 1, and can also include the same or similar primary additives as discussed with reference to the plastic film illustrated in FIG. 1.

Referring now to FIG. 6, plastic film 20 includes two plastic layers 30, 40 and a plurality of particles 50. As can be appreciated, the plastic film can include three or more layers of plastic and have particles at least partially positioned between two or more layers of plastic. As shown in FIG. 6, the two plastic layers contact one another; however, the two plastic layers can be merely contacting one another in multiple locations on the plastic film. The two plastic layers are shown to have generally the same thickness; however, this is not required. A portion of particles 50 is shown to pass through plastic layers 30, 40 such that the particles penetrate the outer surface of both sides of the plastic film. In this non-limiting arrangement for the plastic film, one or both of the plastic layers may be porous and/or permeable; however, this is not required. The thickness of one or both of the layers can be used to control the rate at which the particles interact with liquids, gases, microorganism, etc. that come in contact with the outer surface of one or both of the plastic layers; however, this is not required. The exposure of a portion of particles 50 on both outer surfaces of the plastic film enables the particles to directly contact liquids, gases, microorganism, etc. that come in contact with the outer surface of plastic layers 30, 40. Such direct interaction between the particles and a liquid, gas, microorganism, etc. that come in contact with the particle can result in an increased rate at which the particles achieve their designed function; however, this is not required. The exposure of the particles through plastic layers 30, 40 can also be used to maintain the integrity of the plastic film. When one or more of the particles are designed to absorb a liquid/gas and expand during such absorption, the particle can be designed to expand outwardly from the outer surface of the plastic layers, thereby reducing stresses between the particle and plastic layer; however, this is not required. The plastic film illustrated in FIG. 6 can be used as a liner for a shelf of a refrigerator and function similar to the plastic film illustrated in FIG. 1, and can also include the same or similar primary additives as discussed with reference to the plastic film illustrated in FIG. 1.

Referring now to FIG. 8, plastic film 20 includes two plastic layers 30, 40 and a plurality of particles 50. As can be appreciated, the plastic film can include three or more layers of plastic and have particles at least partially positioned between two or more layers of plastic. As shown in FIG. 8, the two plastic layers contact one another; however, the two plastic layers can be merely contacting one another in multiple locations on the plastic film. The two plastic layers are shown to have different thicknesses; however, this is not required. Particles 50 are shown to be substantially encapsulated between the two plastic layers. This arrangement is similar to the arrangement illustrated in FIG. 2. Particles 50 are also shown to be partially embedded in plastic layer 40. In this non-limiting arrangement for the plastic film, one or both of the plastic layers are porous and/or permeable to enable the particles to interact with liquid, gases, microorganism, etc. that come in contact with the outer surface of one or both of the plastic layers. The thickness of one or both of the layers can be used to control the rate at which the particles interact with liquids, gases, microorganisms, etc. that come in contact with the outer surface of one or both of the plastic layers; however, this is not required. The thickness of plastic layer 30 about a plurality of particles is shown to be thinner than the thickness of plastic layer 30 which is spaced from the particles. This thinner portion of plastic layer 30 can be used to increase the rate at which the particles can interact with liquid, gasses, microorganism, etc. that come in contact with the outer surface of plastic layer 30; however, this is not required. Generally, the ratio of the average thickness of the plastic layer spaced from the particles to the thickness of the thinnest portion about the particles is at least about 1.1:1, and typically about 1.2-20:1. Generally the thinnest portion about the particles is less than about 1.5 mils, and typically about 0.05-1 mils. Plastic layer 40 can be designed as an imperturbable layer or a permeable layer that enable the particles to interact with liquids, gases, microorganism, etc. that come in contact with the outer surface of plastic layer 40. The thinness of plastic layer 30 about the particles can be used to enable one or more particles to penetrate through layer 30, especially when the particles are design to absorb a liquid/gas and expand during such absorption. The ease at which plastic layer 30 enables penetration by the particles can facilitate in maintaining the integrity of the plastic film; however, this is not required. The plastic film illustrated in FIG. 8 can be used as a liner for a shelf of a refrigerator and function similar to the plastic film illustrated in FIG. 1, and also can include the same or similar primary additives as discussed with reference to the plastic film illustrated in FIG. 1.

Referring now to FIG. 3, plastic film 20 includes one plastic layer 60 and a plurality of particles 50. Particles 50 are shown to be partially embedded in plastic layer 60. A portion of particles 50 is also shown to pass through plastic layer 60 such that the particles penetrate the outer surface of one side of the plastic film. In this non-limiting arrangement for the plastic film, the plastic layer can be porous and/or permeable to enable the embedded portion of the particles to interact with liquid, gases, microorganism, etc. that come in contact with the outer surface of the plastic layer; however, this is not required. The thickness of the plastic layer can be used to control the rate at which the particles interact with liquids, gases, microorganisms, etc. that come in contact with the embedded portion of the particles; however, this is not required. The exposure of the particles through plastic layer 60 can also be used to maintain the integrity of the plastic film. When one or more of the particles are designed to absorb a liquid/gas and expand during such absorption, the particle can be designed to expand outwardly from the outer surface of the plastic layer, thereby reducing stresses between the particle and plastic layer; however, this is not required. The plastic film illustrated in FIG. 3 can be used as a liner for a shelf of a refrigerator and function similar to the plastic film illustrated in FIG. 1, and can also include the same or similar primary additives as discussed with reference to the plastic film illustrated in FIG. 1.

Referring now to FIG. 4, plastic film 20 includes one plastic layer 60 and a plurality of particles 50. Particles 50 are shown to be fully embedded in plastic layer 60. In this non-limiting arrangement for the plastic film, the plastic layer is typically porous and/or permeable to enable the embedded portion of the particles to interact with liquid, gases, microorganism, etc. that come in contact with the outer surface of the plastic layer; however, this is not required. The thickness of the plastic layer can be used to control the rate at which the particles interact with liquids, gases, microorganisms, etc. that come in contact with the embedded portion of the particles; however, this is not required. The plastic film illustrated in FIG. 4 can be used as a liner for a shelf of a refrigerator and function similar to the plastic film illustrated in FIG. 1, and can also include the same or similar primary additives as discussed with reference to the plastic film illustrated in FIG. 1.

Referring now to FIG. 7, plastic film 20 includes one plastic layer 60 and a plurality of particles 50. Particles 50 are shown to be partially embedded in plastic layer 60. A portion of particles 50 is also shown to pass through both sides of plastic layer 60 such that the particles penetrate the outer surface of both sides of the plastic film. In this non-limiting arrangement for the plastic film, the plastic layer can be porous and/or permeable to enable the embedded portion of the particles to interact with liquid, gases, microorganism, etc. that come in contact with the outer surface of the plastic layer; however, this is not required. The thickness of plastic layer can be used to control the rate at which the particles interact with liquids, gases, microorganisms, etc. that come in contact with the embedded portion of the particles; however, this is not required. The exposure of the particles through plastic layer 60 can also be used to maintain the integrity of the plastic film. When one or more of the particles are designed to absorb a liquid/gas and expand during such absorption, the particle can be designed to expand outwardly from the outer surface of the plastic layer, thereby reducing stresses between the particle and plastic layer; however, this is not required. The plastic film illustrated in FIG. 7 can be used as a liner for a shelf of a refrigerator and function similar to the plastic film illustrated in FIG. 1, and can also include the same or similar primary additives as discussed with reference to the plastic film illustrated in FIG. 1.

Referring now to FIG. 9, plastic film 20 includes one plastic layer 60 and a plurality of particles 50. Particles 50 are shown to be embedded in plastic layer 60. In this non-limiting arrangement for the plastic film, the plastic layer is typically porous and/or permeable to enable the embedded particles to interact with liquid, gases, microorganism, etc. that come in contact with the outer surface of the plastic layer. The thickness of plastic layer can be used to control the rate at which the particles interact with liquids, gases, microorganisms, etc. that come in contact with the embedded portion of the particles; however, this is not required. The thickness of plastic layer 60 about a plurality of particles is shown to be thinner than the thickness of plastic layer 60 which is spaced from the particles. This thinner portion of plastic layer 60 can be used to increase the rate at which the particles can interact with liquid, gases, microorganism, etc. that come in contact with the outer surface of plastic layer 60; however, this is not required. The thinness of plastic layer 60, especially about the particle, can also be used to enable one or more particles to penetrate through layer 60, especially when the particles are design to absorb a liquid/gas and expand during such absorption. The ease at which plastic layer 60 enables penetration by the particle can facilitate in maintaining the integrity of the plastic film; however, this is not required. Generally, the ratio of the average thickness of the plastic layer spaced from the particles to the thickness of the thinnest portion about the particles is at least about 1.1:1, and typically about 1.2-100:1. Generally the thinnest portion about the particles is less than about 1.5 mils, and typically about 0.05-1 mils. The plastic film illustrated in FIG. 9 can be used as a liner for a shelf of a refrigerator and function similar to the plastic film illustrated in FIG. 1, and can also include the same or similar primary additives as discussed with reference to the plastic film illustrated in FIG. 1.

As can be appreciated, plastic film 20 could also be formed from a combination of two or more of the plastic layer and particles combinations set forth in FIGS. 1-9.

The plastic film layers 30, 40, 60 can be formed in a variety of ways. In one non-limiting process, the polymers that are to be used to form the plastic film are mixed together to form a generally homogeneous mixture. The polymer mixture can then be pelletized for later processing or be directed through an extruder to form a plastic layer. During the mixing of the polymers, one or more primary additives and/or secondary additives can be added to the polymer mixture; however, this is not required. FIG. 4 illustrates a plastic film wherein one or more primary additives were mixed with the polymers prior to extruding the mixture into a plastic layer or film. As can be appreciated, when the polymer mixture is pelletized, the one or more primary additives can be added to the pelletized polymer mixture to form a master batch that is then extrude into the plastic layer or film. During the extrusion process, the pelletized polymer mixture, and one or more primary and/or secondary additives, if added, are subjected to sufficient shear and heat to cause the pelletized polymer mixture to melt. The time and temperature of mixing is controlled to avoid molecular weight degradation of the polymers and/or the one or more primary additives. The extruded plastic sheet or film can then be further formed by a conventional tubular extrusion (blown bubble process). During this process, the plastic film is expanded by a gas and subsequently cooled. The expanded plastic film is then flattened and stretched to obtain the final physical dimensions of the plastic film.

During the stretching of the plastic film, the temperature, pressure and/or tension applied to the plastic layer is controlled so as to not damage the plastic layer and/or bond between the plastic layer and the particles. The stretching of the plastic film can result in the thickness of the plastic material a particle becoming thinner as illustrated in FIG. 9. Alternatively, the stretching of the plastic film can cause one or more particles to penetrate through the outer surface of the plastic layer as illustrated in FIGS. 3 and 7. The plastic film can also be pulled over one or more rollers during the stretching process to facilitate in the thinning of the plastic film and/or cause a plurality of particles to penetrate one or both sides of the plastic film.

In an alternative manufacturing process, the particles of the one or more primary additives can be applied to the surface of a plastic film and then pressed into the plastic layer by use of pressure and temperature. In this process, the temperature is typically selected to merely soften, but not melt the plastic layer. This process can be used to form plastic films as illustrated in FIGS. 3 and 7.

When the plastic film is formed of two of more plastic layers, the one or more primary additives can be applied to the surface of one of the plastic layers and then a second plastic layer can be applied to the first plastic layer to entrap the particles of primary additive between the two plastic layers as illustrated in FIG. 1. Alternatively, one of the plastic layers can be formed as described above with regard to single layer films, and then a second layer of plastic film can then be applied to the first layer of plastic film. Such a process can be used to form the plastic film illustrated in FIGS. 2, 5, 6, and 8. If such a process is used, the plastic layers can be stretch to cause thinning of one or more plastic layers about the particles as illustrated in FIG. 8, or cause one or more particles to penetrate the surface of one or more both plastic layers as illustrated in FIGS. 5 and 6.

Alternatively, two plastic layers can be laminated together and then one or more types of particles can be applied to the surface of a plastic film and then pressed into one or both plastic layers by use of pressure and temperature. In this process, the temperature is typically selected to merely soften, but not melt the plastic layers. This process can be used to form plastic films as illustrated in FIGS. 5 and 6.

As can be appreciated, the plastic film can be designed to be activated by a user. For example, the plastic film could be made as illustrated in FIGS. 1, 2, or 4. When a user removes the plastic film form a roll of film and/or cuts the plastic film from the roll of film, the plastic film is subjected to stretching. This stretching of the plastic film can be used to cause the plastic film to transform form the plastic film illustrated in FIGS. 1, 2 or 4 to the plastic films illustrated in FIGS. 3, 5, 6, 7, 8 or 9. As can be appreciated, these examples are merely illustrative of the many applications and designs of the plastic films that can be formed and used in accordance with the present invention.

Referring now to FIG. 10, there is illustrated a roll 230 of plastic film 20 in the form of plastic sheets 250. One or more sheets 250 of plastic film 20 can be separated from the roll of plastic film by tearing the sheets along perforation 240. In this non-limiting arrangement, the sheets of plastic film can be used in a fashion similar to paper towels or toilet papers. As can be appreciated, the sheets of plastic film could be folded in a form similar to napkins. As can also be appreciated, the sheets of plastic film can be packaged in a fashion similar to baby wipes or facial wipes. As can also be appreciated, the sheets of plastic film can be packaged in the form of sanitary wipes or cleaning wipes. As such, the sheets of plastic film can be packaged in a variety of way, all of which fall within the scope of this invention.

Referring now to FIGS. 10-12, there is illustrated a tile or mat 100 in accordance with the present invention. Although the embodiments illustrated in FIGS. 10-12 have particular applicability to tiles or mats, it will be appreciated that all the concepts and features described with regard to the tiles or mats could also be applied to the sheets of plastic film 20. Typically, the tiles or mats have a greater thickness than the sheet of plastic film. As such, for purposes of this invention, all the features described as follows with regard to the tiles or mats 100 can be included in the plastic film as described above with regard to FIGS. 1-9 and 14.

Referring now to FIG. 10, a tile or mat 100 is formed of a single layer 110 of material. The material used to form the single layer 1 10 can be the same material as described above with regard to the plastic film, or can be or include other materials. For instance, the material could be the same or similar material that is used in currently used shelf mats or liners (PVC coated materials, foam materials, polymer sheets, etc.). The single layer 110 is shown to include two primary additives 120, 130. As can be appreciated, the single layer can include only one type of primary additive or more than two types of primary additives. When two or more primary additives are included in the single layer, the amount of each of the primary additives can be the same or different. In addition, the location of one or more of the primary additives can be uniformly distributed about the single layer or be located in specific regions of the single layer (e.g., top surface region, bottom surface region, middle region, edge region, etc.). The one or more primary additives that can be included in the single layer can be the same or different types of primary additives as discussed above with regard to use in plastic film 20. In one non-limiting configuration, the primary additive 130 is a liquid absorbing primary additive and primary additive 120 is a gas absorbing primary additive. As can be appreciated other or additional types of primary additives can be used. The thickness of the single layer is generally uniform; however, this is not required. The thickness of the single layer is generally less than about one inch and typically about 0.05-0.5 inches when the tile or mat is used for domestic uses (e.g., pantry shelf liner, pots and pan cabinet or shelf liner, glass ware shelf liner, refrigerator shelf liner, freezer shelf liner, etc.); however, it can be appreciated that other thickness can be used.

Referring now to FIG. 11, there is illustrated a tile or mat 100 having two layers 140, 150. The composition of the layers can be the same or different. The thickness of the layers can be the same or different. Each layer is illustrated as including a single primary additive; however, it can be appreciated that one or both layers can include more than one primary additive, and/or one of the layers can be completely absent primary additives. Layer 140 is shown to include primary additive 160 and layer 150 is shown to include primary additive 170. Generally, primary additive 160 and primary additive 170 are different; however, this is not required. The concentrations of the primary additives in each layer can be the same or different. The location of the primary additives and/or the concentration in a particular location in both layers can be the same or different. In one non-limiting arrangement of the tile or mat 100, primary additive 160 is a gas absorbing material and primary additive 170 is a liquid absorbing material. The thickness of the two layers is selected so that the thickness of the tile or mat has an overall thickness of less than about one inch and typically about 0.05-0.5 inch. The two layers can be connected together in a variety of way such as, but not limited to, an adhesive, melt bond, chemical bonding, and/or one or more types of mechanical bonding.

Referring now to FIG. 12, there is illustrated a tile or mat 100 having three layers 140, 150, 180. The composition of the layers can be the same or different. The thickness of the layers can be the same or different. Layers 140, 150 are illustrated as including a single primary additive; however, it can be appreciated that one or both of layers 140, 150 can include more than one primary additive, and/or one of layers 140, 150 can be completely absent primary additives. Layer 140 is shown to include primary additive 160 and layer 150 is shown to include primary additive 170. Generally, primary additive 160 and primary additive 170 are different; however, this is not required. The concentrations of the primary additives in layers 140, 150 can be the same or different. The location of the primary additives and/or the concentration in a particular location in layers 140, 150 can be the same or different. Layer 180 is illustrated as positioned between layers 140, 150. Layer 180 is also shown to not include any type of primary additive. As can be appreciated, layer 180 can include one or more primary additive. The one or more primary additives included in layer 180 can be the same or different primary additives that are included in layer 140 and/or layer 150. In one non-limiting arrangement of the tile or mat 100, primary additive 160 is a gas absorbing material and primary additive 170 is a liquid absorbing material. The thickness of the layers 140, 150, 180 is selected so that the thickness of the tile or mat has an overall thickness of less than about one inch and typically about 0.05-0.5 inch. The thickness of layers 140 and 150 is greater than the thickness of 180; however, this is not required. Layer 180 does not include any primary additives. Layer 180 is designed and formulated so that layer 180 acts as a liquid barrier to inhibit or prevent one or more liquids and/or gases from passing through layer 180. For instance, layer 180 could be designed and formulated to prevent molecules that are the same size or larger than water molecules from passing through layer 180. The three layers can be connected together in a variety of way such as, but not limited to, an adhesive, melt bond, chemical bonding, and/or one or more types of mechanical bonding. All of the layers can be connected in the same manner; however, this is not required.

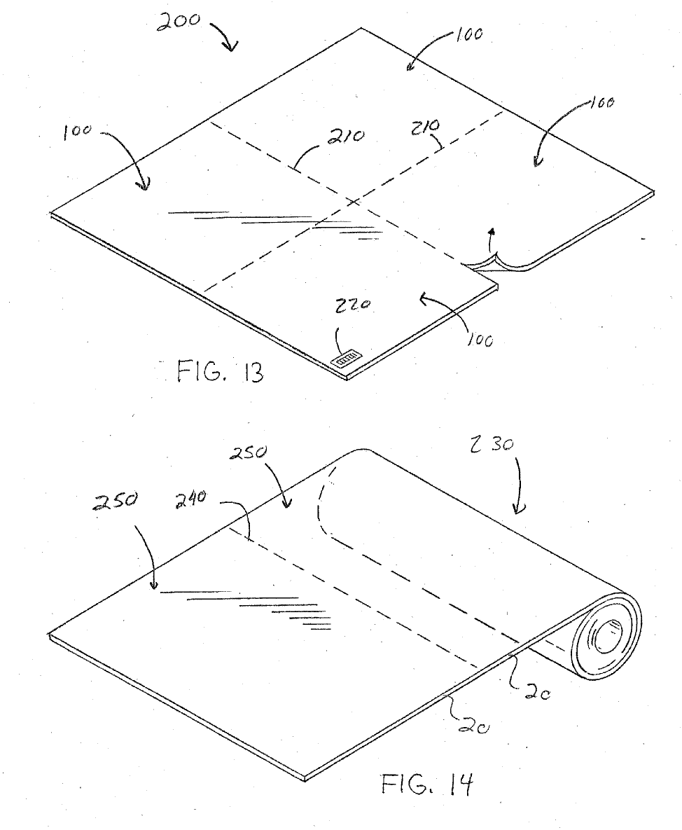

Referring now to FIG. 13, there is illustrated a large tile or mat 200. The large tile or mat 200 can be used as is or be divided into one or more smaller sections so that the user can customize the use of the tile or mats for a particular application and/or location. The large tile or mat 200 includes two perforations 210 to enable the lager tile or mat to be divided into to 2, 3 or 4 smaller tiles or mats 100. As can be appreciated, the larger tile or mat 200 can include only one perforation, or more than two perforations. The pattern of the one or more perforations in the large tile or mat 200 is non-limiting. The pattern of the one or more perforations in the large tile or mat 200 can be selected so that generally square, rectangular or polygonal tiles or mats 100 can be formed from large tile or mat 200, and/or the pattern of the one or more perforations in the large tile or mat 200 can be selected so that non-polygonal (e.g., oval, circular, etc.) tiles or mats 100 can be formed from large tile or mat 200.

As illustrated in FIG. 13, there is an indicator 220 located on one region of large tile or mat 200. As can be appreciated, each tile or mat 100 on the larger tile or mat 200 can include an indicator. The indicator can be used for many different reasons. For example, the indicator can be used to inform the user of the proper orientation and placement of the tile or mat on a shelf. In addition or alternatively, the indicator can be used to inform a user whether the tile or mat needs to be changed. In addition or alternatively, the indicator can be used to inform the user of an environmental change that has occurred during the use of the tile or mat (e.g., some level of change in temperature, some level of change in humidity, etc.). As can be appreciated, the indicator can have other or additional functions. As indicated above, the indicator can have one or more functions. As can be appreciated, the indicator can be located in other or additional regions of the larger mat or tile 200 and/or tiles or mats 100. For instance, the compete tile or mat 100 can include and/or function as an indicator.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1. A plastic film having an outer surface and formed of at least one plastic layer and at least two different primary additives, said at least two primary additives including additives selected from the group consisting of a liquid absorbing material, a gas absorbing material, a biocide, a heat generating material, a foaming agent, or mixtures thereof.

2. The plastic film as defined in claim 1, wherein a first primary additive includes a liquid absorbing material, and a second primary additive is selected from the group consisting of a gas absorbing material, a biocide, or mixtures thereof, said first and second primary additives formed of different materials.

3. The plastic film as defined in claim 1, wherein said plastic layer includes a polyolefin polymer.

4. The plastic film as defined in claim 1, wherein said plastic film has an average thickness of about 1-10 mils.

5. The plastic film as defined in claim 1, wherein at least one of said primary additives is in the form of particles, said particles having an average size of about 0.5-60 microns and an average hardness of at least about 2 on the Mohr scale.

6. The plastic film as defined in claim 2, wherein at least one of said primary additives is in the form of particles, said particles having an average size of about 0.5-60 microns and an average hardness of at least about 2 on the Mohr scale.

7. The plastic film as defined in claim 1, wherein a majority of at least one of said primary additives is fully encapsulated in at least one of said plastic layers.

8. (canceled)

9. The plastic film as defined in claim 1, wherein at least a portion of at least one of said primary additives penetrates said outer surface of the plastic film.

10. (canceled)

11. The plastic film as defined in claim 1, wherein said plastic film includes a top and bottom outer surface, at least a portion of at least one of primary additives penetrating said top and bottom outer surface of said plastic film.

12. The plastic film as defined in claim 10, wherein said plastic film includes a top and bottom outer surface, at least a portion of at least one of primary additives penetrating said top and bottom outer surface of said plastic film.

13. The plastic film as defined in claim 1, including a second plastic layer, at least a portion of at least one of the two primary additives are positioned at least partially between the two plastic layers.

14. The plastic film as defined in claim 6, including a second plastic layer, at least a portion of at least one of the two primary additives are positioned at least partially between the two plastic layers.

15. The plastic film as defined in claim 6, including a second plastic layer, at least a portion of at least one of the two primary additives are positioned at least partially between the two plastic layers.

16. The plastic film as defined in claim 12, including a second plastic layer, at least a portion of at least one of the two primary additives are positioned at least partially between the two plastic layers.

17. The plastic film as defined in claim 1, wherein at least a portion of said primary additive is activatable when said plastic layer is stretched.

18. The plastic film as defined in claim 6, wherein at least a portion of said primary additive is activatable when said plastic layer is stretched.

19. The plastic film as defined in claim 16, wherein at least a portion of said primary additive is activatable when said plastic layer is stretched.

20. A plastic film having an outer surface and formed of at least one plastic layer and at least one primary additive, said plastic film having an average thickness of about 1-20 mils, said plastic layer including a polyolefin polymer, said primary additive in the form of particles, at least a portion of said particles penetrating said outer surface of the plastic film, said particles having an average size of about 0.5-60 microns and an average hardness of at least about 2 on the Mohr scale, said primary additive including an additive selected from the group consisting of a liquid absorbing material, a gas absorbing material, a biocide, a heat generating material, a foaming agent, or mixtures thereof.

21. The plastic film as defined in claim 20, wherein a majority of said particles of said primary additive penetrates said outer surface of the plastic film.

22. The plastic film as defined in claim 21, wherein said at least one plastic layer includes two different primary additives, a first primary additive including a liquid absorbing material, and a second primary additive being selected from the group consisting of a gas absorbing material, a biocide, or mixtures thereof, said first and second primary additive formed of a different material.

23. The plastic film as defined in claim 22, wherein at least a portion of said particles are fully encapsulated in at least one of said plastic layers.

24. The plastic film as defined in claim 22, wherein said plastic film includes a top and bottom outer surface, at least a portion of said particles penetrating said top and bottom outer surface of said plastic film.

25. The plastic film as defined in claim 23, wherein said plastic film includes a top and bottom outer surface, at least a portion of said particles penetrating said top and bottom outer surface of said plastic film.

26. The plastic film as defined in claim 20, including a second plastic layer.

27. The plastic film as defined in claim 26, wherein at least a portion of said at least one primary additive positioned at least partially between the two plastic layers.
